(19) United States
(12) Patent Application Publication
(10) Pub. No.: US 2017/0020106 A1
(43) Pub. Date: Jan. 26, 2017

(54) Vehicle Mounted Animal Enclosure with Unique Door Control Mechanisms

(71) Applicant: Cory Dalzell, Baldur (CA)

(72) Inventor: Cory Dalzell, Baldur (CA)

(21) Appl. No.: 14/803,295

(22) Filed: Jul. 20, 2015

(51) Int. Cl. A01K 1/06; E05C 3/12; E05C 3/16; E05B 65/00; E05B 15/02

(52) U.S. Cl. CPC A01K 1/0613; E05B 65/0007; E05B 15/0205; E05C 3/16; E05C 3/12; E05B 2015/023

(57) ABSTRACT

A portable enclosure for capturing and retaining an animal features a pen carried alongside an ATV, a front opening in the pen, and at least one door movable between open and closed positions at the front opening. A lock member is carried above the front opening, and is displaceable into and out of a locking position engaging the door. A rotatable actuation member resides overhead of the lock member and is operable by a foot pedal to draw the at least one lock member upwardly out of the locking position to unlock the door. The same lock member acts in both the open and closed positions of the door by way of cooperation with strike plates on the door panel and an extension member projecting therefrom. The strike plates are shaped to return the lock member to a ready state for automatic locking during opening and closing of the door.

### FIELD OF THE INVENTION

The present invention relates generally to the field of animal husbandry, and more particularly to vehicle-mounted enclosures for catching calves in the field in a manner isolating the calves from protective mother cows for the safety of the farmer or rancher.

### BACKGROUND

In the field of animal husbandry, it has been previously proposed to mount a portable enclosure to an all-terrain vehicle (ATV) or other vehicle and use the same for the purpose of catching calves in the field shortly after birth to enable the farmer or rancher to apply identification tags, perform medical procedures or carry out other processing of the calves. The vehicle and enclosure combination allows the farmer or rancher to capture and process each calf in a manner safely isolated from the mother cow, whose protective instincts may otherwise pose a threat to the farmer or rancher attending to the calf.

Examples of prior art enclosures of this type are found in U.S. Pat. No. 6,964,245, U.S. Pat. No. 7,389,746 and U.S. Pat. No. 8,061,303, and U.K. Patent Application GB2449900. Other examples of vehicle-carried livestock enclosures or carriers are found in U.S. Pat. No. 5,785,006, U.S. Pat. No. 6,035,808 and U.S. Pat. No. 7,685,970.

Of the forgoing references, GB2449900 and U.S. Pat. No. 7,389,746 are the most relevant to the present invention, in that they attach to an ATV in a position residing alongside same and feature an openable/closeable door at a leading front end of the enclosure so that a calf can be captured by driving the vehicle up alongside the animal with the door in the open position in order to receive the calf through the open door into the interior of pen, at which point the door is promptly closed by the ATV operator. An operator opening in the vehicle-facing side of the enclosure allows the farmer or rancher to enter the enclosure for access to the captured calf in a manner safely isolated from the surrounding field, where the protective mother cow is likely to be nearby.

Applicant has designed a new calf catching enclosure of this general type in which unique mechanisms for controlling operation of the openable and closeable doors are employed.

### SUMMARY OF THE INVENTION

According to one aspect of the invention there is provided a portable enclosure for attachment to a ground vehicle for capturing and retaining an animal, the portable enclosure comprising:

a pen arranged for attachment to the ground vehicle in a working position residing thereaside;

an front opening in the pen at a front end thereof that faces forwardly of the ground vehicle when the pen is attached thereto in the working position;

at least one door movably mounted to the pen and movable between a closed position obstructing the front opening of the pen and an open position revealing the front opening of the pen;

at least one lock member movably carried on the pen at a position overlying the front opening therein, the lock member being displaceable upwardly and downwardly between a locking position engaging the at least one door and a releasing position withdrawn from engagement with the at least one door; and

at least one rotatable actuation member rotatably carried on the pen in a position overhead of the lock member and linked to the lock member such that rotation of the at least one actuation member in an unlocking direction draws the at least one lock member upwardly out of the locking position into the releasing position to allow movement of the at least one door between the open and closed positions.

Preferably the at least one lock member is arranged to be engagable with the at least one door in both the open and closed positions thereof.

Preferably the at least one door comprises:

at least one door panel that resides in the front opening of the pen the closed position and, in said closed position, is engaged by the locking position of the at least one locking member to lock the at least one door in the closed position; and

at least one extension member that extends out from the at least one door panel for engagement by the at least one locking member in the open position of the at least one door to lock the at least one door in the open position.

Preferably the at least one door comprises a latching point at which the at least one door is engagable by downward movement of a respective locking member into the locking position, and an inclined ramp surface approaching the latching point in a manner increasing in elevation theretoward to lift the respective locking member out of the locking position during movement of the at least one door into a position aligning said respective locking member with the latching point, whereupon the locking member falls into the locking position and into engagement with the latching point.

Preferably the latching point is carried on the at least one door panel and is engagable by downward movement a respective locking member into the locking position with the at least one door in the closed position, and a second latching point is carried on the at least one extension member and is engagable by downward movement of the respective locking member into the locking position with the at least one door in the open position.

Preferably the at least one door comprises a strike plate mounted atop at least one door panel of said at least one door and defining the inclined ramp surface, and the first latching point comprises a hole in the strike plate for engagement by a respective locking member in the closed and locking positions of the at least one door and the respective locking member

Preferably there is a second inclined ramp surface carried on the at least one extension member and approaching the second latching point in a manner increasing in elevation theretoward to lift the respective locking member out of the locking position during movement of the at least one door into the open position, whereupon the locking member falls into the locking position and into engagement with the second latching point.

Preferably the at least one locking member is biased into the locking position.

Preferably at least one spring biases the at least one locking member into the locking position.

Preferably the at least one door is biased into the closed position.

Preferably at least one gas spring is coupled between the pen and the at least one door and biases the at least one door into the closed position.

Preferably a foot pedal is movably mounted on the pen at a position adjacent a bottom end thereof at a side thereof that resides adjacent to the ground vehicle in the working position, and a linking device is coupled between the foot pedal and the rotatable actuation member so as to drive rotation thereof under actuation of the foot pedal.

Preferably the linking device comprises a link having a first end coupled to the foot pedal at a position eccentrically offset from a pivot axis of the foot pedal and a second end coupled to the rotatable actuation member at a position eccentrically offset from a rotational axis thereof such that pivoting of the foot pedal about its pivot axis drives rotation of the rotatable actuation member.

Preferably the foot pedal is arranged to drive rotation of the rotatable actuation member in the unlocking direction under depression of the foot pedal.

Preferably the rotatable actuation member is linked to the at least one lock member by at least one flexible member.

Preferably the at least one flexible member is a flexible chain.

Preferably the at least one door comprises two doors, and the at least one locking member comprises two locking members, one for each of the two doors.

According to a second aspect of the invention there is provided a portable enclosure for attachment to a ground vehicle for capturing and retaining an animal, the portable enclosure comprising:

a pen arranged for attachment to the ground vehicle in a working position residing thereaside;

an front opening in the pen at a front end thereof that faces forwardly of the ground vehicle when the pen is attached thereto in the working position;

at least one door movably mounted to the pen and movable between a closed position obstructing the front opening of the pen and an open position revealing the front opening of the pen; and

a locking mechanism having at least one locking member arranged to engage with the at least one door in both the open and closed positions thereof, whereby the same at least one locking member locks the at least one door in both the open and closed positions.

Preferably the locking mechanism is arranged to automatically engage the at least one locking member with the at least one door in both the open and closed positions thereof.

Preferably the at least one door comprises:

at least one door panel that resides in the front opening of the pen the closed position and, in said closed position, is engaged by the at least one locking member to lock the at least one door in the closed position; and

at least one extension member that extends out from the at least one door panel for engagement by the at least one locking member in the open position of the at least one door to lock the at least one door in the open position.

### BRIEF DESCRIPTION OF THE DRAWINGS

One embodiment of the invention will now be described in conjunction with the accompanying drawings in which:

FIG. 1 is a front side perspective view of a vehicle-carried calf-catching enclosure according to the present invention.

FIG. 2 is an overhead plan view of the vehicle-carried calf-catching enclosure.

FIG. 3 is a partial closeup view of the vehicle-carried calf catching enclosure, showing a spring loaded locking member at the front end thereof for automatically locking doors of the enclosure in both open and closed positions.

FIG. 4 schematically illustrates use of a foot-pedal lock release mechanism, as would be seen from the left side of FIG. 1, to release the spring loaded locking member of FIG. 3 and enable automatic closing of the doors from their open positions.

FIGS. 5A, 5B and 5C are overhead views of one of the doors of the vehicle-carried calf catching enclosure in closed, open and intermediate positions, respectively, as would be viewed along cross-sectional line A-A of FIG. 1.

FIGS. 6A through 6D illustrate use of an inclined ramp surface of a strike plate on a door panel of one of the doors of the vehicle-carried calf catching enclosure during closing of the door in order to raise the spring loaded locking member to a ready state for subsequent automatic re-deployment thereof once the door is fully closed.

FIGS. 7A and 7B another a strike plate on an extension member of one of the doors, which features another ramp surface that is inclined in two directions relative to an axis of the extension member in order to similarly ready the spring-loaded locking member for automatic re-deployment thereof once the door is fully opened.

In the drawings, like characters of reference indicate corresponding parts in the different figures.

### DETAILED DESCRIPTION

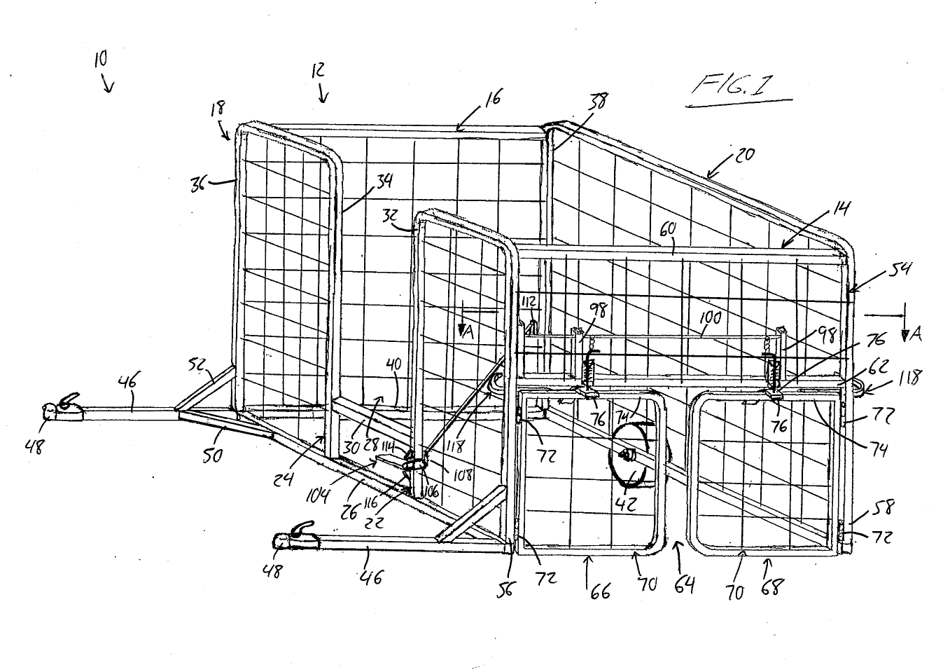

FIG. 1 illustrates a calf-catching enclosure 10 of the present invention for mounting on an ATV or other vehicle 200 in a position residing alongside same, as shown in the overhead plan view of FIG. 2. The enclosure features a pen 12 having parallel front and rear walls 14, 16 and parallel inner and outer side walls 18, 20 extending between the front and rear walls to delimit an interior space of the pen between the four walls. Each wall includes a frame of rectangular metal tubing, and a mesh or grid formed of smaller metal rods perpendicularly crossing one another between members of the frame. The two side walls 18, 20 consist of an inner wall 18 that faces laterally toward the ATV and an opposing outer wall 20 that faces laterally away therefrom. The outer wall 20 consists of a singular panel whose area is bound on all four sides thereof by respective frame members, and which is overlaid with the respective mesh or grid. The inner wall 18 instead consists of two smaller panels 22, 24 upstanding from a bottom frame member 26 of the wall on opposite sides of an operator access opening 28 in the wall 18 through which the user of the enclosure 10 can enter and exit the interior space of the pen 12. Except for a reinforcement member 30 of the frame that lies parallel to a bottom frame member 26 at a short height thereabove to span between upright frame members 32, 34 of the two panels 22, 24, the operator access opening 28 is entirely unobstructed to give the operator convenient access to the interior of the pen. The rear wall 16 features a singular mesh or grid spanning between respective upright frame members 36, 38 at the rear ends of the two side panels overtop of a bottom frame member 40 of the rear wall 16.

A ground wheel 42 is rotatably mounted to a bottom frame member 44 of the outer side wall 20 to rollingly carry the pen on the ground during use. At the inner side of the pen 12, a pair of lateral arms 46 project perpendicularly from the bottom frame member 26 of the inner side wall 18 at opposing ends thereof that reside at the corners between this side wall 18 and the front and rear walls 14, 16. These arms 44 lie in the same plane as the bottom frame member 26 of the inner wall, and each carry a respective hitch coupler 46 at the distal end of the arm furthest from the bottom frame member 26. The hitch couplers 48 mate with a respective hitch balls at the front and rear ends of the ATV, as shown in FIG. 2. Each arm is held rigidly by angled reinforcement members 50, 52 extending from the arm to the bottom and upright frame members 26, 36, 56 of the inner side wall. As shown in FIG. 2, with each hitch coupler 48 mated and locked to the respective hitch ball of the ATV 200, the ground wheel 42 rollingly supports the pen 12 alongside the ATV for conveyance therewith in a forward working direction F during operation of the ATV. Use of two hitch couplers at the same low elevation in the plane of the of the bottom frame members of the pen to connect to two lower frame-level ball hitches on the ATV provides the enclosure with confident stability during use.

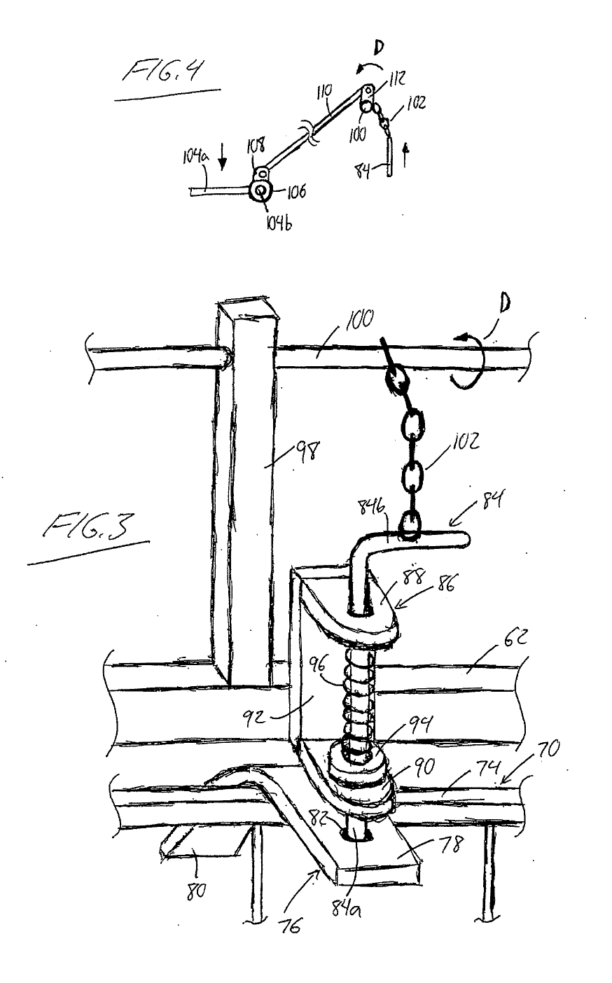

The front wall 14 features an upper panel 54 bound at its ends by a pair of upright frame members 56, 58 shared by the front wall with the inner and outer side walls 18, 20. Upper and lower cross-bars 60, 62 spanning perpendicularly between the upright frame members 56, 58 complete the perimeter of the upper panel 54. A respective mesh or grid of the panel is fixed in place over the front side or rear of the panel's perimeter. The upper panel 54 spans only a partial elevation of the front wall 14, for example approximately half of this elevation in the illustrated embodiment. A front opening 64 of the pen 12 resides beneath this fixed upper panel 54, and has a pair of doors 66, 68 pivotally mounted therein for movement of the doors 66, 68 between closed positions obstructing this opening 64 (FIGS. 1, 2, 5A) and open positions (FIG. 5B) revealing the front opening 64 to enable entrance of a calf to the interior space of the pen through this opening 64. Each door 66, 68 features a main door panel 70 having a frame that delimits a generally rectangular area occupied by, or overlaid with, a respective mesh or grid, just like the panels of the pen walls. Each door panel 70 is hinged to a respective one of the upright frame members 56, 58 at the corners between the front and side walls of the pen 12 for swinging movement of the door between the open and closed positions about the generally vertical pivot axes of the hinges 72.

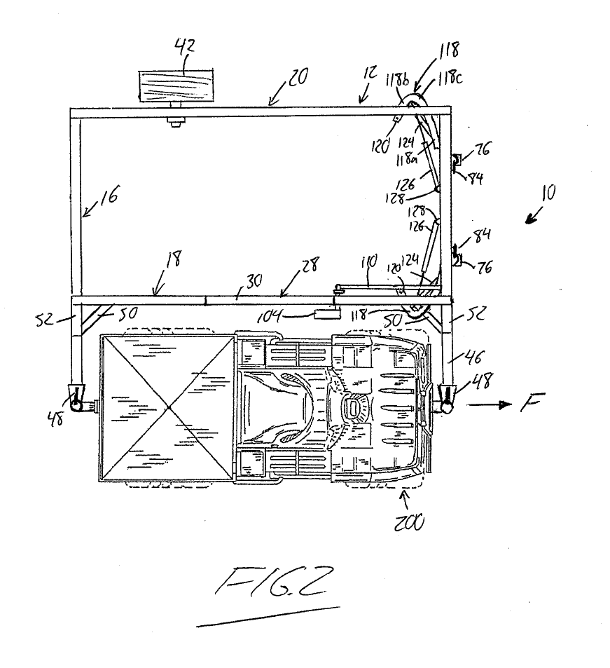

A top frame member 74 of each door panel 70 has a respective strike plate 76 welded or otherwise affixed thereatop. As best shown in the closeup view of FIG. 3, each strike plate 76 has a bent shape with a horizontal front portion 78 cantilevered forwardly from the horizontally oriented top frame member 74 of the door panel 70, and an angled rear portion 80 sloping downwardly and rearwardly from the top frame member 74 of the door panel 70. The terms horizontal and vertical, as used herein, are with particular reference to the illustrated level orientation of the pen 12 in FIGS. 1 and 2, in which the coplanar bottom frame members of the pen reside in a horizontal plane, and the walls and doors of the pen all reside in vertical planes with the top frame. It will be appreciated that in use, the specific orientation of the pen may vary somewhat and reside in a slightly tilted orientation, for example due to variation in the ground surface on which the ATV and pen are disposed, variation between the hitch to ground measurement of the ATV versus the wheel axis to ground measurement of the pen's ground wheel, and or due to variation between hitch to ground measurement at the front and rear ends of the ATV. The front portion 78 of each strike plate 76 features a respective hole 82 passing vertically therethrough to define a latching point at which the door is engagable by a respective locking member 84 mounted to the upper panel of the front wall for locking the door in the closed position.

With continued reference to FIG. 3, each locking member 84 in the illustrated embodiment is an L-shaped latch pin having a vertical leg 84a for engaging the strike plate 76 of the respective door at the latching point hole 82 therein, and a horizontal leg 84b projecting laterally from the top end of the vertical leg 84a. Each locking member 84 is carried by a respective mounting bracket 86, which features two forward-projecting horizontal flanges 88, 90 fixed to a backing plate 92, which in turn is affixed to the front face of the lower cross-bar 62 of the front wall's upper panel 54 above the front opening 64 of the pen 12. The vertical leg 84a of the locking member 84 passes through a pair of aligned holes in the two flanges 88, 90. A stop collar 94 is affixed to the vertical leg 84a of the locking member 84 at a position residing between the two flanges 88, 90 of the mounting bracket 86, and has a diameter exceeding that of the hole in the lower flange 90 of the mounting bracket 86. The stop collar 94 limits downward movement of the locking member 84 and defines a default lock-engaging position thereof in which the vertical leg 84a of the locking member reaches downwardly far enough to penetrate the latch point hole 82 in the strike plate 76 of the door panel 70, when in the closed position. A compression spring 96 coils around the vertical leg 84a of the locking member 84 between the stop collar 94 and the upper flange 88 of the mounting bracket 86 in order to bias the locking member downwardly into the default lock-engaging position. In the closed position of each door, the door panel 70 resides within the front opening 64 of the pen beneath the lower cross-member 62 of the front wall's upper panel 54, and the front portion 78 of the door panel strike plate 76 reaches forwardly out from the front opening 64 of the pen to align the hole 82 of the strike plate 76 with the holes of the two mounting bracket flanges 88, 90, thereby enabling engagement of the locking member 84 with the strike plate in order to latch the door in place.

A respective upright 98 stands vertically upward from the lower cross-bar 62 of the upper panel 54 of the front wall 14 at a position adjacent each one of the mounting brackets 86, and a rotatable actuation member 100 is provided in the form of a horizontal rod or shaft journaled to the two uprights 98 for rotation about the shaft's longitudinal axis. Beside each upright 98, a respective flexible member 102 in the form of a flexible chain has an upper end welded or otherwise affixed to the rotatable actuation member 100, and a lower end welded or otherwise affixed to the horizontal leg 84b of the respective locking member 84. The flexible members 102 thereby link the rotatable actuation member 100 to the two locking members 84 such that rotation of the rotatable actuation member 100 in an unlocking direction D acts to wind more of the flexible member 102 around the rotatable actuation member 100, thereby pulling the two locking members 84 upward.

A foot pedal 104 is pivotally mounted to the upright member 32 of the front panel 22 of the inner side wall 18 at a short height above the lower frame member 26 thereof. The foot pedal 104 is in the form of a flat plate 104a affixed to a circular rod 104b at its forward end. The circular rod 104 reaches horizontally into the interior space of the pen 12 through a hollow sleeve 106 that is affixed to the front side of the upright frame member 32. A connection lug 108 is affixed to the end of the rod 104b that resides inside the pen, and projects radially upward from the rod 104b. A linking device 110 in the form of an elongated tie-rod has one end thereof coupled to the connection lug 108 at a point located eccentrically outward from the rod 104b. The rotatable actuation member 100 likewise features a respective connection lug 112 projecting radially upward therefrom for connection to the second end of the linking device 110 at a position located eccentrically outward from the rotatable actuation member 100. A pair of stop tabs 114, 116 are affixed to the upright frame member 32 on which the foot pedal is carried at the side of the upright frame member 32 facing toward the ATV, and are positioned respectively above and below the foot pedal plate 104a to limit pivoting of the foot pedal 104 in both upward and downward directions about its horizontal pivot axis, as defined by the rod 104b. With the linking device 110 connected between the foot pedal 104 and the rotatable actuation member 100, depression of the foot pedal plate 104a downward toward the lower stop 116 pulls the actuation member's connection lug 112 rearward to rotate the actuation member 100 in the unlocking direction D that wraps more of the flexible chains 102 rearwardly over the top of the actuation member 100.

In addition to the door panel and the respective strike plate 76 mounted thereon, each door features an extension member 118 affixed to the rear facing side of the top frame member 74 of the door panel 70, as perhaps best shown in FIG. 5A. The extension member of the illustrated embodiment is formed of a bent piece of rectangular metal tubing, which has a first portion 118a extending generally along the top frame member 74 past the outer end thereof nearest to the side wall of the pen to which the door is hinged. Here, the extension member 118 bends through a curvature of more than 90° but less than 180°, so that a second portion 118b of the extension member 118 extends rearwardly away from the door panel 70 while angling back toward, without reaching, a vertical plane P that cuts perpendicularly through the door panel 70 at the location of the strike panel 76 thereon. In the door's closed position, the extension member reaches outwardly through an opening in the mesh or grid of the respective side wall 18,20 of the pen, as can be seen in FIG. 2.

The distal end of each extension member carries a respective strike plate 120, which like the strike plate 76 of each door panel 70 features a hole 122 passing perpendicularly therethrough. A cross-member 124 spans between the two portions 118a, 118b of the extension member at a distance from the curved bend 118c that joins these two portions together. A biasing member 126 in the form of a tension gas spring has one end pivotally coupled to the cross-member 124, and the other end pivotally coupled to the lower cross-bar 62 of the front wall's upper panel 54 near a mid-point thereof, for example at a mounting lug 128 projecting rearwardly from the cross-bar 62, as shown in FIGS. 2 and 5.

The strike plate 120 of each extension member 118 is tilted relative to a longitudinal axis A₁ of the second portion 118b of the extension member 118 in two different dimensions. Firstly, moving along the longitudinal axis A₁ toward the free end 120a of the strike plate 120 that is situated furthest from the distal end 118 of the extension member, the strike plate 120 slopes obliquely downward relative to the longitudinal axis A₁ by an acute angle, as shown in FIG. 7B. Secondly, the strike plate 120 is tilted about its own longitudinal axis A₂ so that its side edge 120b facing toward the door panel 70 is lower than its other side edge 120c that faces away from the door panel 70. Accordingly, the strike plate 120 on each extension arm 118 is tilted relative thereto in both the length and width directions of the strike plate 120.

In the open position of each door, the extension member 118 thereof positions its strike plate 120 beneath the respective locking member mounting bracket 86 with the strike plate hole 122 in alignment with the holes of the mounting bracket flanges 88, 90, thereby enabling receipt of the locking member 84 in a latched state with the strike plate 120. Accordingly, the strike plate 120 on the extension member acts similar to the strike plate 76 of the door panel 70, but to lock the door in the open position rather than the closed position. FIGS. 5A and 5B show one of the doors 66 in its closed and open positions respectively, while FIG. 5C shows the door 66 in an intermediate position during movement between the open and closed positions.

To prepare the calf catching enclosure 10 for use, the two hitch couplers 48 are coupled to the front and rear hitch balls of an ATV. The installation of front and rear frame-height ball hitches on an ATV is already known in the art, and therefore not described herein in further detail. At the front end of the enclosure, at a position inside or outside the pen, the user manually pulls up the locking member 84 of one door (against the downward biasing force of the respective compression spring 96) in order to withdraw the vertical leg 84a of the locking member from the latching point hole 82 in the respective door panel strike plate 76, thereby unlocking the closed door. With the locking member held in this withdrawn position, the user swings the door outwardly from the closed position in the front opening 64 of the pen into the open position shown in FIG. 5B. With the locking member released 84, the respective compression spring 96 forces the respective locking member 84 downwardly into engagement with the latching point hole 122 in the extension member strike plate 120, thereby locking the door in the door in the open position. This process of unlocking, opening and automatically relocking the door is then repeated for the other door, thus putting the enclosure in a ready condition for use.

The user drives the ATV in the forward working direction F, thus conveying the pen 12 forwardly alongside the ATV with the front doors of the pen secured in the open positions. The user drives up alongside a calf, thereby transitioning the calf from the open environment into the interior of the pen via the front opening 64 due to the open state of the doors during this process. As soon as the calf is inside the pen, the user, from the operating seat of the ATV, depresses the foot pedal plate 104a of the foot pedal 104 downwardly, thus withdrawing both locking members 84 upwardly into their lock-releasing positions unlocking the currently open doors of the pen, at which point the two gas springs 126 automatically pull the two doors closed in order to secure the calf inside the pen.

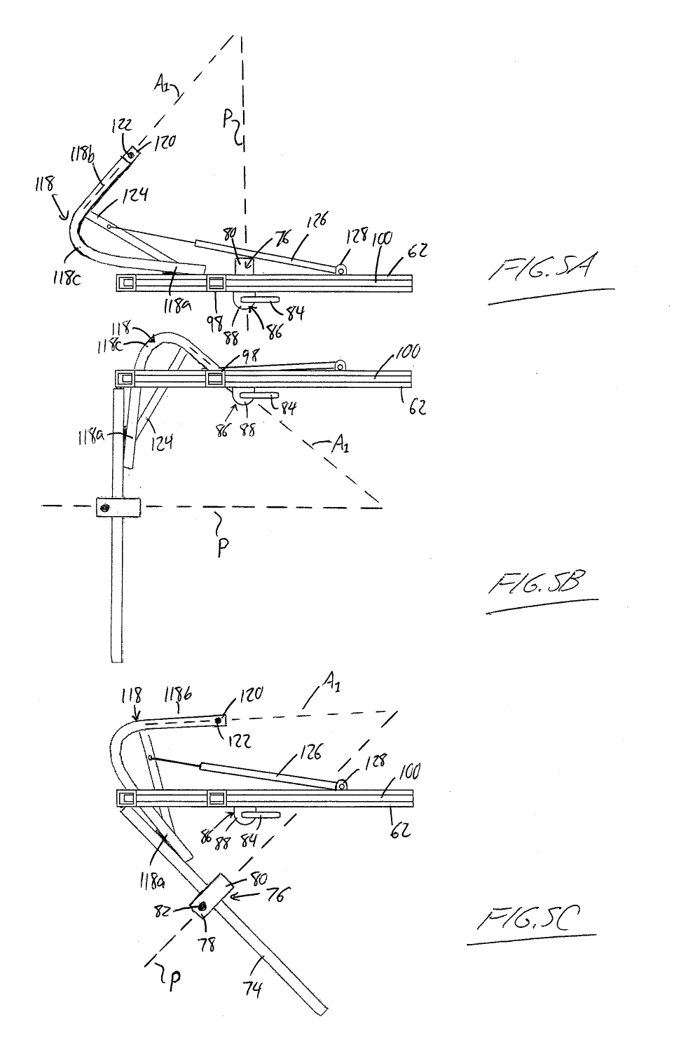

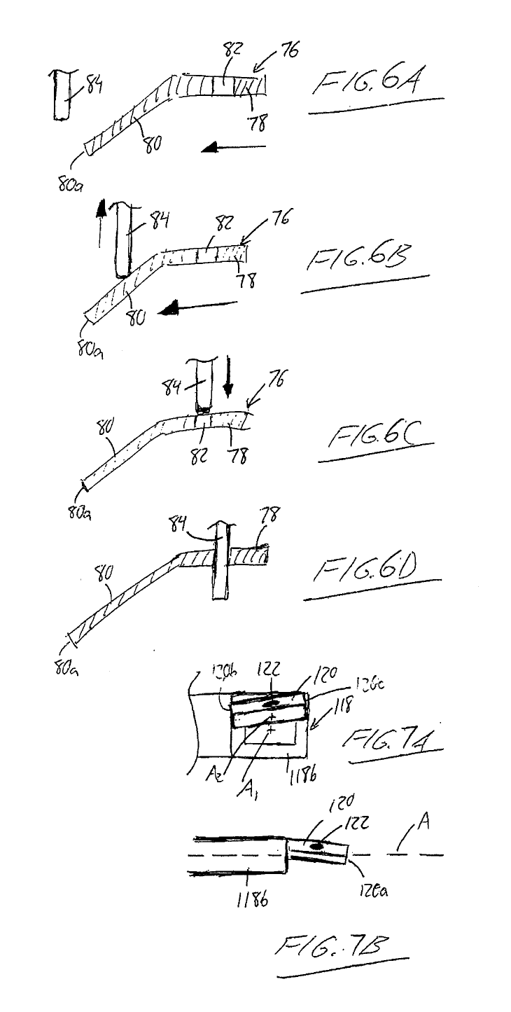

FIG. 6 schematically illustrates how each locking member 84 and the corresponding door panel strike plate 76 cooperate during the closing of the respective door to achieve automatic re-locking of the door upon arrival thereof in the fully closed position. As the door is being closed, i.e. moving from the fully open position of FIG. 5B through the intermediate position of FIG. 5C and onward toward the fully closed position of FIG. 5A, the inclined ramp portion 80 of the door panel strike plate 76 approaches the locking member's mounted position on the front wall of the pen, as schematically shown in FIG. 6A. The lower end 80a of the inclined ramp portion 80 is situated at an elevation below that at which the lower end of the locking member's vertical leg 84a resides when in its lowest spring-biased lock-engaging position. The elevation of the horizontally cantilevered portion 78 of the door panel strike plate 76, i.e. the elevation at which the inclined ramp portion 80 joins to the horizontal portion 78, equates to an attainable elevation of the locking member's lower end that occurs prior to full compression of the respective spring 86. Turning to FIG. 6B, as the inclined ramp portion 80 of the door panel strike plate 76 reaches the mounted position of the locking member 84, the bottom end of the locking member comes into contact with the ramp portion 80 and rides upwardly therealong as the door panel continues toward the closed position, whereby the locking member 84 is pushed upwardly against the bias of the compression spring 86. Turning to FIG. 6C, the lower end of the locking member 84 rides up onto the horizontal portion 78 of the strike plate 76 and comes into alignment with the latch hole 82 as the door reaches the fully closed position. At this point, with reference to FIG. 6D, the compression spring 86 forces the bottom end of the locking member 84 downwardly through the latch hole 82, thereby automatically locking the door in the fully closed position.

This self-locking closure of the door means that the pedal-initiated closing of the two doors during use of the enclosure to capture a calf will automatically lock the doors in their closed positions to prevent escape of the calf from the interior of the pen. The user can enter the interior of the pen from the operator seat of the ATV through the operator access opening 28 in the inner side wall 18 of the pen, and tend to the calf in a position safely isolated from the mother cow by the walls of the pen and by the ATV, which bocks the mother cow's access to the operator access opening 28. Once the calf has been tagged, treated or otherwise processed, the user remains safely inside the pen and manually lifts the horizontal leg 84b of the locking member 84 of one or both of the doors in order to release the locking member from its latched condition with the respective door panel strike plate 76, and pushes the respective door panel outward from the closed position toward the open position to allow the calf to exit the pen and return to the surrounding field environment.

When opening the doors during preparation of the enclosure for use, the tilted orientation of each extension member strike plate 120 works in the same manner as the bent shape of the door panel strike plate 76 to force the respective locking member 84 upwardly as the door approaches the position in which it is to be locked. That is, the extension member strike plate 120 slopes upwardly toward the latch point hole 122 therein from the distal end 120a and from lower side edge 120b, whereby the area between the latch point hole 122 and distal end 120a and lower side edge 120b defines an inclined ramping surface that increases in elevation toward the latch point hole 122 in order to drive the lower end of the locking member 84 upwardly against the bias of the respective compression spring 86 as the respective door approaches the fully open position of FIG. 5B from the closed and intermediate positions of FIGS. 5A and 5C. As the door reaches the fully opened position aligning the latch point hole 122 with the raised lower end of the locking member 84, the compression spring 86 forces the lower end of the locking member 84 downwardly through the latch point hole 122 in order to automatically lock the door in the fully opened position.

The forgoing embodiment of the present solution includes a number of novel, inventive and potentially advantageous features, including the unique arrangement of a rotatable actuation member for raising the downwardly biased locking members up into released positions allowing movement of the doors, foot pedal operation of the actuation member for convenient unlocking of the doors from the operator seat of the ATV, the use of the same members 84 to secure each doors in both the open and closed positions, and the use of inclined strike plate ramp surfaces to automatically lift the locking members into ready positions for subsequent deployment during an automatic locking action.

While the illustrated embodiment features two doors, each having a respective locking member and pair of strike plates, it will be appreciated that an alternate embodiment may feature a singular door spanning the width of the front opening from one hinged side while employing similar use of a the same lock member to lock the door in the open and closed positions. It will also be appreciated that the unique overhead actuation member for releasing the locked condition of the door(s) may rely on an input other than a foot operated pedal to initiate its rotational action. Additionally, the overhead actuation member and/or the use a sloped strike plate to control the locking member(s) may be used regardless of whether that locking member is used to lock the door in both open and closed positions, or to lock the door in only one of those positions. While the illustrated embodiment uses gas springs to bias the doors toward the closed position, and compression springs to bias the locking members toward the locking position, it will be appreciated that other biasing means may be employed. For example, in one embodiment, gravitational biasing of the locking member(s) downwardly toward their lock-engaging positions may be sufficient without an additional resilient such as the disclosed compression spring. It will also be appreciated that the particular shape of the pen and its interior space may be varied.

For example, in one embodiment (not shown) the rear wall may be built out over a partial span of its width to accommodate a smaller floor-equipped cage inside the larger pen for transporting a calf from its captured position in the field, whereby the built-out area of the rear wall would change the shape of the overall interior space of the pen from the rectangular volume of the illustrated embodiment.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A portable enclosure for attachment to a ground vehicle for capturing and retaining an animal, the portable enclosure comprising:
a pen arranged for attachment to the ground vehicle in a working position residing thereaside;
an front opening in the pen at a front end thereof that faces forwardly of the ground vehicle when the pen is attached thereto in the working position;
at least one door movably mounted to the pen and movable between a closed position obstructing the front opening of the pen and an open position revealing the front opening of the pen;
at least one lock member movably carried on the pen at a position overlying the front opening therein, the lock member being displaceable upwardly and downwardly between a locking position engaging the at least one door and a releasing position withdrawn from engagement with the at least one door; and
at least one rotatable actuation member rotatably carried on the pen in a position overhead of the lock member and linked to the lock member such that rotation of the at least one actuation member in an unlocking direction draws the at least one lock member upwardly out of the locking position into the releasing position to allow movement of the at least one door between the open and closed positions.

2. The portable enclosure of claim 1 wherein the at least one lock member is arranged to be engagable with the at least one door in both the open and closed positions thereof.

3. The portable enclosure of claim 2 wherein the at least one door comprises:
at least one door panel that resides in the front opening of the pen the closed position and, in said closed position, is engaged by the locking position of the at least one locking member to lock the at least one door in the closed position; and
at least one extension member that extends out from the at least one door panel for engagement by the at least one locking member in the open position of the at least one door to lock the at least one door in the open position.

4. The portable enclosure of claim 1 wherein the at least one door comprises a latching point at which the at least one door is engagable by downward movement of a respective locking member into the locking position, and an inclined ramp surface approaching the latching point in a manner increasing in elevation theretoward to lift the respective locking member out of the locking position during movement of the at least one door into a position aligning said respective locking member with the latching point, whereupon the locking member falls into the locking position and into engagement with the latching point.

5. The portable enclosure of claim 1 wherein the at least one door comprises a strike plate mounted atop at least one door panel of said at least one door, the strike plate having a hole therein positioned for engagement by a respective locking member in the closed and locking positions of the at least one door and the respective locking member, and the strike plate has an inclined ramp portion that increases in elevation toward the hole to lift the respective locking member out of the locking position during movement of the at least one door into a position aligning said respective locking member with the hole in the strike plate, whereupon the locking member falls through the hole into the locking position.

6. The portable enclosure of any one of claim 3 wherein the at least one door comprises:
a first latching point carried on the at least one door panel at which the at least one door is engagable by downward movement a respective locking member into the locking position with the at least one door in the closed position;
a second latching point carried on the at least one extension member at which the at least one door is engagable by downward movement of the respective locking member into the locking position with the at least one door in the open position.

7. The portable enclosure of claim 6 wherein the at least one door comprises:
a first inclined ramp surface carried on the at least one door panel and approaching the first latching point in a manner increasing in elevation theretoward to lift the respective locking member out of the locking position during movement of the at least one door into the closed, whereupon the respective locking member falls into the locking position and into engagement with the first latching point; and
a second inclined ramp surface carried on the at least one extension member and approaching the second latching point in a manner increasing in elevation theretoward to lift the respective locking member out of the locking position during movement of the at least one door into the open position, whereupon the locking member falls into the locking position and into engagement with the second latching point.

8. The portable enclosure of claim 1 wherein the at least one locking member is biased into the locking position.

9. The portable enclosure of claim 8 comprising at least one spring biasing the at least one locking member into the locking position.

10. The portable enclosure of claim 1 wherein the at least one door is biased into the closed position.

11. The portable enclosure of claim 1 comprising at least one gas spring coupled between the pen and the at least one door and biasing the at least one door into the closed position.

12. The portable enclosure of claim 1 comprising a foot pedal movably mounted on the pen at a position adjacent a bottom end thereof at a side thereof that resides adjacent to the ground vehicle in the working position, and a linking device coupled between the foot pedal and the rotatable actuation member so as to drive rotation thereof under actuation of the foot pedal.

13. The portable enclosure of claim 12 wherein the linking device comprises a link having a first end coupled to the foot pedal at a position eccentrically offset from a pivot axis of the foot pedal and a second end coupled to the rotatable actuation member at a position eccentrically offset from a rotational axis thereof such that pivoting of the foot pedal about its pivot axis drives rotation of the rotatable actuation member.

14. The portable enclosure of claim 12 wherein the foot pedal is arranged to drive rotation of the rotatable actuation member in the unlocking direction under depression of the foot pedal.

15. The portable enclosure of claim 1 wherein the rotatable actuation member is linked to the at least one lock member by at least one flexible member.

16. The portable enclosure claim 15 wherein the at least one flexible member is a flexible chain.

17. The portable enclosure of claim 1 wherein the at least one door comprises two doors, and the at least one locking member comprises two locking members, one for each of the two doors.

18. A portable enclosure for attachment to a ground vehicle for capturing and retaining an animal, the portable enclosure comprising:
a pen arranged for attachment to the ground vehicle in a working position residing thereaside;
an front opening in the pen at a front end thereof that faces forwardly of the ground vehicle when the pen is attached thereto in the working position;
at least one door movably mounted to the pen and movable between a closed position obstructing the front opening of the pen and an open position revealing the front opening of the pen; and
a locking mechanism having at least one locking member arranged to engage with the at least one door in both the open and closed positions thereof, whereby the same at least one locking member locks the at least one door in both the open and closed positions.

19. The portable enclosure of claim 18 wherein the locking mechanism is arranged to automatically engage the at least one locking member with the at least one door in both the open and closed positions thereof.

20. The portable enclosure of claim 18 wherein the at least one door comprises:
at least one door panel that resides in the front opening of the pen the closed position and, in said closed position, is engaged by the at least one locking member to lock the at least one door in the closed position; and
at least one extension member that extends out from the at least one door panel for engagement by the at least one locking member in the open position of the at least one door to lock the at least one door in the open position.
